(19) United States
(12) Patent Application Publication
(10) Pub. No.: US 2024/0354691 A1
(43) Pub. Date: Oct. 24, 2024

(54) VISUALLY-UNDETECTABLE FONT COLOR TRACKING SYSTEMS FOR PHYSICALLY PRINTING AND DISTRIBUTING PRINT DOCUMENTATION

(71) Applicant: Truist Bank, Charlotte, NC (US)

(72) Inventors: Oliver Murray, Richmond, VA (US); David Bryant Pinkleton, South Chesterfield, VA (US)

(73) Assignee: Truist Bank, Charlotte, NC (US)

(21) Appl. No.: 18/305,665

(22) Filed: Apr. 24, 2023

(51) Int. Cl. G06Q 10/0833; G06Q 30/018

(52) U.S. Cl. CPC G06Q 10/0833; G06Q 30/018

(57) ABSTRACT

Systems and methods transmit, across a network, digital document(s) to a third-party entity, the digital document(s) comprising metadata comprising a search key data string located within digital text of the digital document(s), the metadata comprising a visually-undetectable font color, the digital document(s) being transmitted to the third-party entity for physical printing, based on converting the digital text into physical text printed on paper, and distribution. Communication(s) are received, across the network, from the third-party entity comprising archived status update information regarding physical printing and distribution of physical document(s) associated with the digital document(s), the communication(s) comprising the metadata comprising an updated version of the search key data string. Based on receiving the communication(s) and using the updated version of the search key data string, a status assessment is generated identifying status of the physical printing and the distribution of the physical document(s) performed by the third-party entity.

### FIELD OF THE INVENTION

This invention relates generally to the field document tracking and reconciliation, and more particularly embodiments of the invention relate to tracking systems for physically printing and distributing print documentation that incorporates visually-undetectable font color.

### BACKGROUND OF THE INVENTION

Many enterprises (e.g., companies, universities, organizations, institutions, etc.) commonly distribute a physical mailpiece (e.g., letters, postcards, flat, and other parcels) through mail couriers throughout the United States and worldwide. Oftentimes, various procedures are taken to help these enterprises track the mailpiece to determine whether the intended recipient received the mailpiece. Tracking numbers and various other processes have been implemented by mail couriers to help provide information as to whether the intended recipient received the mailpiece.

However, when intermediary entities such as print vendors that provide bulk printing for these enterprises are introduced into the mailing process there are additional variables that make it difficult for the originating enterprise to know whether the mailpiece was actually received by the print vendor, sent by the print vendor, received by the end recipient, etc.

Thus, a need exists for improved systems and methods for helping enterprises know the status of the mailpiece.

### BRIEF SUMMARY

Shortcomings of the prior art are overcome and additional advantages are provided through the provision of a visually-undetectable font color tracking system for physically printing and distributing print documentation. The system includes a memory, one or more processors in communication with the memory, and program instructions executable by the one or more processors. In particular, the program instructions are executable to, in part, transmit, across a network, one or more digital documents to a third-party entity, wherein the one or more digital documents comprises metadata comprising a search key data string located within digital text of the one or more digital documents, the metadata comprising a visually-undetectable font color, the one or more digital documents being transmitted to the third-party entity for physical printing, based on converting the digital text into physical text printed on paper, and distribution. Further, one or more communications are received across the network from the third party entity and comprise archived status update information regarding physical printing and distribution of one or more physical documents associated with the one or more digital documents, the one or more communications comprising the metadata comprising an updated version of the search key data string. In addition, based on receiving the one or more communications and using the updated version of the search key data string, a status assessment is generated that identifies status of the physical printing and the distribution of the one or more physical documents performed by the third-party entity.

Additionally, disclosed herein is a computing environment for print document reconciliation. The computing environment includes one or more computer-readable storage media, one or more processors in communication with the one or more computer readable storage media, and program instructions executable by the one or more processors via at least one computer readable storage medium of the one or more computer readable storage media. In particular, the program instructions are executable to, in part, receive, from an entity and via an embedding software application, one or more digital documents comprising metadata that comprises a search key data string located within digital text of the one or more digital documents, the metadata comprising a visually-undetectable font color. Further, the one or more digital documents received are archived. One or more copies of the one or more digital documents are physically printed for distribution. In addition, one or communications are distributed regarding the physically printed one or more copies and distribution of the physically printed one or more copies, the one or more communications comprising the metadata that comprises an updated version of the search key data string.

Also disclosed herein is a computer-implemented method. The computer-implemented method includes, in part, transmitting, across a network, one or more digital documents to a third-party entity, wherein the one or more digital documents comprises metadata comprising a search key data string located within digital text of the one or more digital documents, the metadata comprising a visually-undetectable font color, the one or more digital documents being transmitted to the third-party entity for physical printing, based on converting the digital text into physical text printed on paper, and distribution. Further, the method includes receiving, across the network, one or more communications from the third-party entity comprising archived status update information regarding physical printing and distribution of one or more physical documents associated with the one or more digital documents, the one or more communications comprising the metadata comprising an updated version of the search key data string. In addition, based on receiving the one or more communications and using the updated version of the search key data string, a status assessment is generated identifying status of the physical printing and the distribution of the one or more physical documents performed by the third-party entity.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

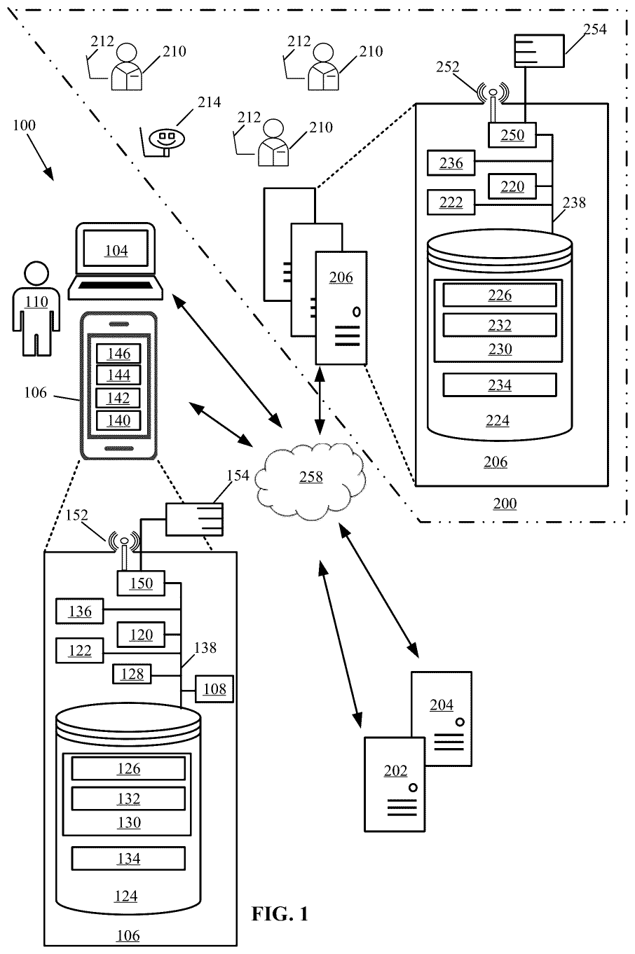

FIG. 1 illustrates a computing environment that includes a visually-undetectable font color tracking system for physically printing and distributing print documentation, in accordance with an embodiment of the present invention;

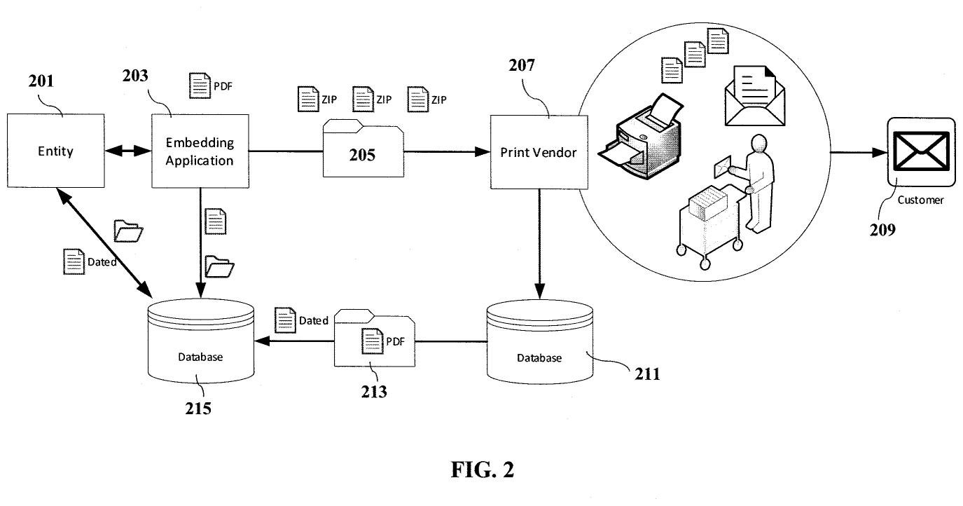

FIG. 2 depicts an example methodology for tracking documentation for physical printing and distribution, in accordance with an embodiment of the present invention;

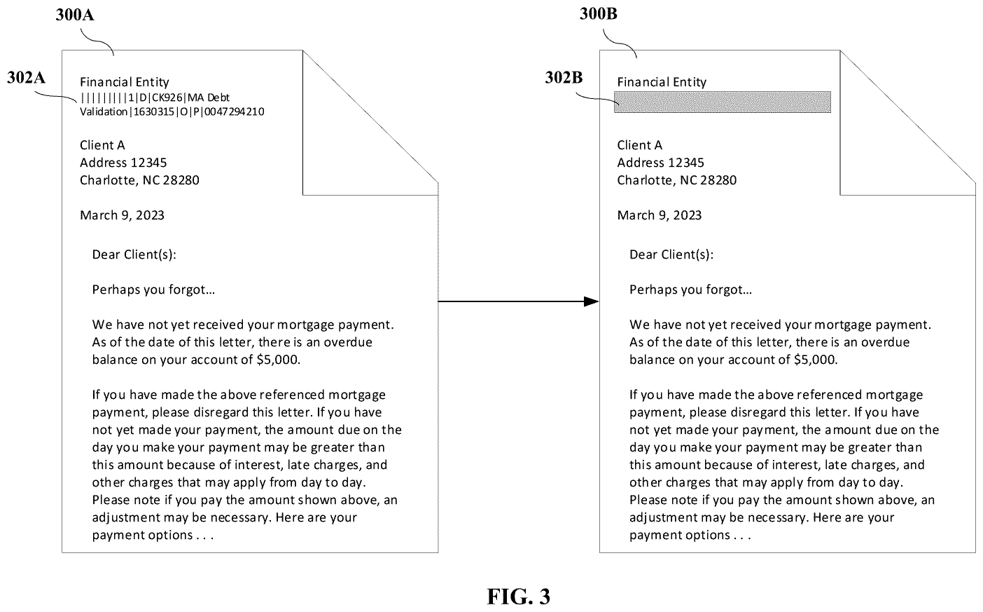

FIG. 3 depicts an example process for providing a visually-undetectable font color tracking system for physically printing documents;

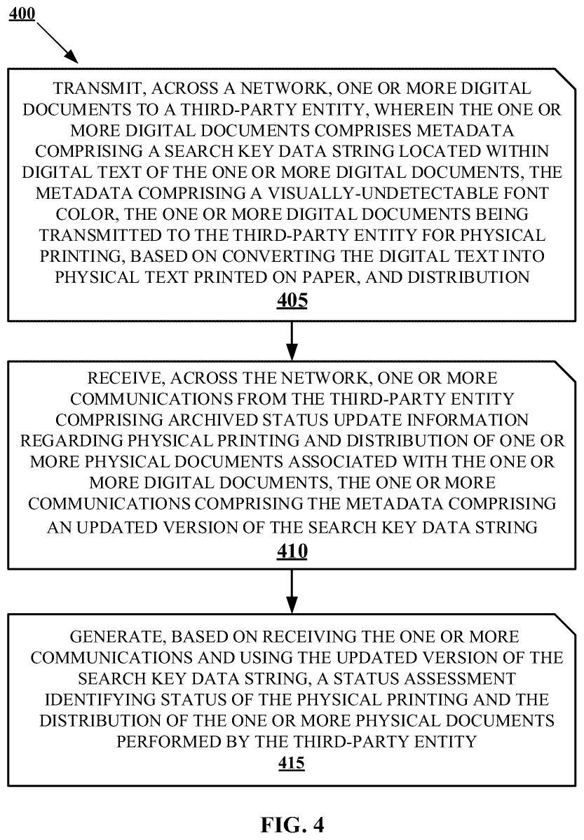

FIG. 4 depicts a block diagram of an example method of a visually-undetectable font color tracking system for physically printing and distributing print documentation, in accordance with an embodiment of the present invention; and

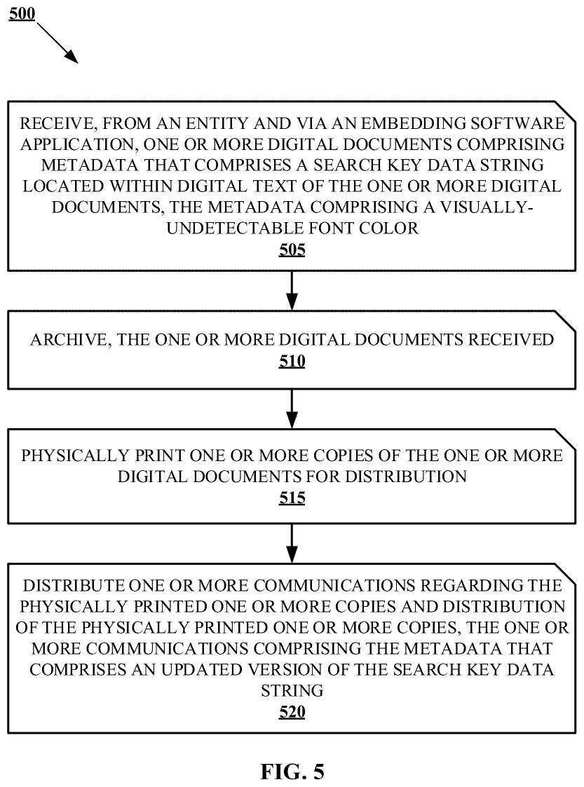

FIG. 5 depicts a block diagram of an example method for print document reconciliation, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

Like numbers refer to like elements throughout. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “couple”, “coupled”, “couples”, “coupling”, “fixed”, “attached to”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about”, “approximately”, or “substantially” for any numerical values or ranges indicate a suitable dimensional tolerance that allows the device, part, or collection of components to function for its intended purpose as described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

As used herein, the terms “enterprise” or “provider” generally describes a person or business enterprise that hosts, maintains, or uses computer systems that provide functionality for the disclosed systems and methods. In particular, the term “enterprise” may generally describe a person or business enterprise providing goods or services. Interactions between an enterprise system, print vendor system, and a user device can be implemented as an interaction between a computing system of the print vendor, and a user device of a user of the enterprise. For instance, user(s) may provide various inputs that can be interpreted and analyzed using processing systems of the user device and/or processing systems of the print vendor system. Further the print vendor computing system and the user device may be in communication via a network. According to various embodiments, the print vendor system and/or user device(s) may also be in communication with another external or third-party server of a third party system that may be used to perform one or more server operations. In some embodiments, the functions of one illustrated system or server may be provided by multiple systems, servers, or computing devices, including those physically located at a central computer processing facility and/or those physically located at remote locations.

Embodiments of the present invention are described herein, with reference to flowchart illustrations and/or block diagrams of computer-implemented methods and computing systems according to embodiments of the invention. Each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus or apparatuses (the term “apparatus” includes systems and computer program products). In particular, the computer readable program instructions, which be executed via the processor of the computer or other programmable data processing apparatus, create a means for implementing the functions/acts specified in the flowchart and/or block diagram block or blocks.

In one embodiment, these computer readable program instructions may also be stored in one or more computer-readable storage media that can direct a computer or other programmable data processing apparatus, and/or other devices, to function in a particular manger, such that a computer readable storage medium of the one or more computer-readable storage media having instructions stored therein comprises an article of manufacture including instructions which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block or blocks.

In another embodiment, these computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions, whether stored in the computer-readable storage medium and/or computer-readable memory may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable instructions for implementing the specified logical function(s). Additionally, the alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, or the functions of the blocks may sometimes be executed in the reverse order, depending upon the functionality involved.

FIG. 1 illustrates a computing environment 100 that includes a visually-undetectable font color tracking system for physically printing and distributing print documentation, according to at least one embodiment of the present invention. The computing environment 100 generally includes a user 110 (e.g., an employee of an enterprise) that benefits through use of services and products offered by a third-party enterprise through print vendor system 200. The computing environment 100 may include, for example, a distributed cloud computing environment (private cloud, public cloud, community cloud, and/or hybrid cloud), an on-premise environment, fog-computing environment, and/or an edge-computing environment. The user 110 accesses services and products of the print vendor system 200 by use of one or more user devices 104, 106. Example user devices 104, 106 may include a laptop, desktop computer, tablet, a mobile computing device such as a smart phone, a portable digital assistant (PDA), a pager, a mobile television, a gaming device, an audio/video player, a virtual assistant device or other smart home device, a wireless personal response device, or any combination of the aforementioned, or other portable device with processing and communication capabilities.

In the illustrated example, the mobile device 106 is illustrated in FIG. 1 as having exemplary elements, the below descriptions of which apply as well to the computing device 104. The user device 104, 106 can include integrated software applications that manage device resources, generate user interfaces, accept user inputs, and facilitate communications with other devices among other functions. The integrated software applications can include an operating system, such as Linux®, UNIX®, Windows®, macOS®, iOS®, Android®, or other operating system compatible with personal computing devices. Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system used on personal computers, central computing systems, phones, and other devices.

The user 110 can be any individual, a group, associated with the entity that is in possession of or has access to the user device 104, 106. Although the user 110 may be singly represented in some figures, in at least in some embodiments the user 110 is one of many such that group of users through multiple user devices utilize the computing environment 100 to communicate with the print vendor system 200.

The user device 104, 106, but as illustrated with reference to the mobile device 106, includes components such as, at least one of each of a processor 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processor 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user, or required or related to any or all of the applications or programs 130.

The memory device 122 is operatively coupled to the processor 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory additionally or alternatively can include an electrically erasable programmable read-only memory (EEPROM), flash memory or the like.

According to various embodiments, the memory device 122 and storage device 124 may be combined into a single storage medium. The memory device 122 and storage device 124 can store any of a number of applications that comprise computer-executable instructions and code executed by the processing device 120 to implement the functions of the user device 104, 106 described herein. For example, the memory device 122 may include such applications as a conventional web browser application and/or an enterprise-distributed application (e.g., a mobile application), collectively referred to herein as a “web portal”. These applications also typically provide a graphical user interface (GUI) on the display 140 that allows the user 110 to communicate via the user device 104, 106 with, for example, a print vendor system 200, and/or other devices or systems. For instance, the GUI on the display 140 may include features for displaying information and accepting inputs from users, and may include fillable text boxes, data fields, hyperlinks, pull down menus, check boxes, and the like. In one embodiment, when the user 110 may participate in a digital data collection program to indicate attributes associated with human capital resources of an enterprise, such as the enterprise associated with the print vendor system 200.

In particular, in various embodiments, the user 110 may download, sign into, or otherwise access an embedding-software application to transmit one or more documents that include metadata to a print vendor system 200 of a print vendor. In other embodiments, the user 110 interacts with the print vendor system 200 via a web browser application in addition to, or instead of, the downloadable embedding software application. In some embodiments, a credentialed system is not required in order to access the web browser of the print vendor system 200, whereas in other embodiments authentication of a user may be necessary in order to provide access to the print vendor system 200.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices may include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices of the input and output system 136 may include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the print vendor system 200, and at least some outputs in such examples correspond to data representing enterprise-side actions and communications in two-way communications between a user 110 and the print vendor system 200.

According to one embodiment, the input and output system 136 may include an optical instrument (e.g., camera 146) configured to capture an image. For instance, the optical instrument may include one or more lenses and one or more image sensors (e.g., a charge coupled device (CCD) sensor) configured to convert photons into an electrical signal. For example, pixels of each the image sensors may each include a photodiode (e.g., a semiconductor) that becomes electrically charged in accordance with the strength of the light that strikes the photodiode, where the electrical charge is then relayed to be converted to an electrical signal. In one embodiment, a series of pulses may be applied to the one or more image sensors to relay the accumulate charges within each photodiode in succession down a row of photodiodes to an edge of the respective image sensor. Other optical instrument functionalities are also contemplated herein.

In one embodiment, the input and output system 136 may also be configured to obtain and process various forms of authentication to obtain authentication information of a user 110 in order to provide, for example, access to a specific web portal of the print vendor system 200. For instance, the web portal may be accessed based on the user providing authentication information to log in to the web portal in order to perform various functionalities described herein. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a GPS configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138 (e.g., system bus), connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems, such as print vendor system 200. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, short message service (SMS), enterprise messaging service (EMS), multimedia messaging service (MMS) messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, Global Positioning System (GPS) may be included for navigation and location-related data exchanges, ingoing and/or outgoing. Communications may also or alternatively be conducted via the connector 154 for wired connections such as by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

Computing environment 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, a single system or server may provide the functions of one or more systems, servers, or illustrated components. In some embodiments, the functions of one illustrated system or server may be provided by multiple systems, servers, or computing devices, including those physically located at a central facility, those logically local, and those located as remote with respect to each other.

The print vendor system 200 can offer any number or type of services and products to one or more users 110. In some examples, the print vendor system 200 offers printing and distribution services. Use of the words “service(s)” or “product(s)” herein can be interchangeable. In at least some examples, any number of print vendors 210 can be employed or utilized by the print vendor system 200 to provide printing and distribution services. Print vendors 210 may utilize computing devices 212 to facilitating printing one or more copies of one or more digital documents.

The print vendor system 200 can be accessed, used, or controlled, in whole or in part, by a third-party entity directly or tangentially associated with the user 110 and/or enterprise. For instance, as non-limiting examples, the third-party entity may be paid by the enterprise to print and distribute physical documents to customers of the enterprise.

The print vendor system 200 may employ a web-based framework with a user interface, a back-end server data model, and tableau reporting to capture each manager's view of the demand within their roles and positions and their assessment of each resources' ability in order to provide micro-level and macro-level insights. The enterprise system may leverage computing device 104 or mobile device 106 to allow the user 110 to access various tools and functionalities associated with the print vendor system 200. Various embodiments may utilize some, all, or none of several functionalities, tools, components, or processes such as data processing, resource allocation, monitoring activities, disk and file management, communications, presentations, cybersecurity, artificial intelligence, machine learning, etc. The program or system may be compiled or otherwise generated, transmitted, and/or distributed, using machine code that can be executed by a server, the computing device 104, and/or mobile device 106. Various systems, programs, and/or portions thereof may be fully automated and/or incorporate user inputs. Any number of print vendors 210 and/or automated system(s) 214 may be employed or utilized by the print vendor system 200. Non-limiting examples of print vendors 210 can include print vendor entities, employees of print vendors, contractors, consultants, advisors, managers, or other individuals associated with the print vendor system 200.

In various examples, the program or system may be compiled utilizing a Platform as a Service (PaaS) or Infrastructure as a Service (IaaS) that the print vendors 210 can access. A PaaS does not permit the print vendors 210 to manage or control the underlying cloud infrastructure, but this service may enable the print vendors 210 to deploy user-created or acquired applications onto the cloud infrastructure using programming languages and tools provided by the provider of the application. A IaaS provides the print vendors 210 with permission to provision processing, storage, networks, and other computing resources as well as run arbitrary software (e.g., operating systems and applications) thereby giving the print vendors 210 full control over operating systems, storage, deployed applications, and potentially select networking components (e.g., host firewalls).

Print vendors 210 may utilize computing devices 212 to assist in printing one or more documents. The computing devices 212 can include a personal computer, a smart phone, or tablet computing device, other mobile/computing device(s), printer, and/or other peripheral machine which makes a persistent representation of graphics or text on paper. Further, in some examples, the diagrammatic representation of the components of user device 104, 106 also apply to certain computing devices 212. Computing devices 212 individually or collectively include input and output devices, (e.g., a touch screen, a monitor, a keyboard, printer, etc.) for the print vendors 210 to input and receive information. Other non-limiting examples of input and output devices or components utilized by the computing devices 212 include one or more of each, any, and all of a keypad, a wireless or wired keyboard, a touch-screen, a touchpad, a microphone, a speaker, a mouse, a joystick, a pointer device, a button, a switch, a light, an LED, a soft key, an infrared sensor, personal response device, a camera (e.g., a digital camera), a buzzer, a bell, a printer, and/or other input and output device(s). Example printers may include inkjet printers, laser printers, solid ink printers, continuous ink printers, LED printers, dot matrix printers and/or A3 printers. Inputs made via the input/output devices of the computing devices 212 by one or more print vendors 210 can be made via voice, text or graphical indicia selections in order to facilitate compilation of the program or system that is to communicate with the user device 104, 106. According to various embodiments, computing devices 212 may primarily serve as inputs or outputs to the computing system 206 of the print vendor system 200. Automated system(s) 214 may incorporate or otherwise utilize artificial intelligence to facilitate compilation of the program or system. For instance, the automated system(s) 214 may automatically process one or more digital documents for physical printing without any involvement by human agents of the print vendors. According to various embodiments, automated system(s) 214 may primarily serve as inputs or outputs to the computing system 206 of the print vendor system 200.

The print vendor system 200 can be configured to generate data manually or to obtain data from a third party source such as, for example, a cloud storage service or remote database. Such data that may be generated, downloaded, or otherwise obtained may include, for example, tracking numbers obtained from mail couriers or other mailpiece related information obtained from the mail couriers. In one example, the automated system(s) 214 print vendors 210 may access third party systems using a software application (e.g., an integrated mobile software application or an application programming interface (API) software application) compatible with the third party system that can be integrated with the computing system 206 and accessible via the computing devices 212 to facilitate communication between software and systems. In another embodiment, the print vendors 210 access third-party systems using a web browser application software to access a web-based software interface (e.g., a website) associated with the mail couriers.

The computing system 206 may have various components similar to the user device 104, 106. For instance, in one example the computing system 206 may include at least one of each of a processing device 220, and a memory device 222 for use by the processing device 220, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data and files, such as those for customer accounts/profiles, enterprise data, print vendor data, industry data, historical data, files downloaded or received from other devices, and other data items preferred by the print vendor and/or enterprise or required or related to any or all of the applications or programs 230.

As illustrated, the computing system 206 includes an input/output system 236, which generally refers to, includes, and/or is operatively coupled with computing devices 212 and automated system(s) 214, as well as various other input and output devices. According to various embodiments, the computing system 206 may be used to distribute the digital data collection program as, for example a Software-as-a-Service (SaaS) that can be accessed by the user device 104, 106 on a subscription basis via a web browser or mobile application. SaaS may provide a user 110 with the capability to use applications running on a cloud infrastructure of the print vendor system 200, where the applications are accessible using the user device 104, 106 via a thin client interface such as a web browser and the user 110 is not permitted to manage or control the underlying cloud infrastructure (i.e., network, servers, operating systems, storage, or specific application capabilities that are not user-specific) of the print vendor system 200.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device 104, 106.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, near-field communication device, and other transceivers. In addition, GPS (Global Positioning System) may be included for navigation and location-related data exchanges, ingoing and/or outgoing. Communications may also, or alternatively, be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices 104, 106, the computing devices 212, computing device 206, and/or print vendor system 200 which may be one or any number centrally located or distributed, are in communication through one or more networks, referenced as network 258 in FIG. 1.

The network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of this description. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMAX, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, frames using frame relay, voice, video, data, and other suitable information between network addresses. The network 258 may also include one or more local area networks (LANs), radio access networks (RANs), metropolitan area networks (MANs), wide area networks (WANs), personal area networks (PANs), WLANs, campus area network (CAN), metropolitan area network (MAN), storage-area network (SAN), all or a portion of the internet and/or any other communication system or systems at one or more locations.

The network 258 may incorporate a cloud platform/data center that support various service models including Platform as a Service (PaaS), Infrastructure-as-a-Service (IaaS), and/or Software-as-a-Service (SaaS). The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, third-party PaaS, third-party IaaS, external databases, business entities, enterprises, organizations, institutions, companies, government entities, clubs, and groups of any size are all within the scope of the description. In at least one example, the external systems 202 and 204 represent mail courier systems that provide industry-specific data that can communicate with or be accessed by the computing devices 212 in order to access various courier-related information such as origination location, shipment tracking information, mailing classification, mailing information, and certification information. According to various embodiments, external systems 202 and 204 may utilize software applications that function using external resources that are available through a third-party provider such as SaaS, PaaS, or IaaS service models. Such external systems 202, 204 include the third party systems accessible via the computing devices 212 using a software application (e.g., an integrated mobile software application or an API software application) that can be integrated with the computing system 206 to facilitate communication between software and systems by mapping computer-readable commands and data formats between systems. In another embodiment, the third party system may be accessible by the computing devices 212 using a web-based software interface (e.g., a website).

In certain embodiments, one or more of the systems described herein such as the user device (referring to either or both of the computing device 104 and the mobile device 106), the print vendor system 200, and/or the external systems 202 and 204 are, include, or utilize virtual resources. Such virtual resources include cloud resources or virtual machines. The virtual resources may utilize a cloud-computing configuration to provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud-computing configuration so that the resources may be shared as needed.

According to one embodiment, a user 110 may transmit, across a network 258, one or more digital documents to the print vendor system 200 via the user device 104, 106 and based thereon the print vendor system 200 may archive the one or more digital documents and cause one or more copies of the one or more digital documents to be printed and/or distributed via a mail courier. In order to initiate the interaction, the user 110 may email the documents to a print vendor that can be accessed via computing devices 212, the documents may be accessible via a shared database, and/or the documents could be otherwise transmitted by the print vendor 210 of the print vendor system 200.

The documents also have metadata located within digital text of the documents, where the metadata includes a visually-undetectable font color. The print vendor 210 may have received previously communication indicating where the metadata would be located in the documents in order to identify the metadata. The metadata may include, for example, (i) document type, (ii) customer information, and/or (iii) account information.

FIG. 2 depicts an example methodology for tracking documentation for physical printing and distribution, in accordance with an embodiment of the present invention. The methodology provides a way to reconcile print documents throughout the lifecycle of each individual document. In particular, searchable document-level timestamp information is automatically tracked and stored for stakeholders within an enterprise. This methodology is effectuated by using document metadata that can be embedded within text of the document when, for example, a digital document is generated by an entity 201 (e.g., indicating the document type, customer information, account information, etc.), when the digital document has been sent to a print vendor 207 to be printed (e.g., status information), when the digital document has been archived by the print vendor 207, when a copy of the digital document has been printed by the print vendor 207, when the printed copy of the digital document has been mailed, where the printed copy of the digital document was mailed from, where the printed copy of the digital document was mailed to, tracking number information used by the mail courier, the type of mailing classification used (e.g., first class, priority, priority mail express, ground, standard, overnight, same-day, two-day, etc.), and/or certification information (e.g. mailing receipt, verification that the mailpiece was delivered, etc.). This methodology may be implemented via the entity's customer communication management system or other internal processes or systems used to communicate with customers via printed and mailed communication.

Advantageously, the disclosed methodology may allow enterprises, particularly those required to meet certain communication requirements, with full visibility into the document lifecycle to determine where a document is at any given time. This eliminates the guesswork as to whether a document was adequately handled when print vendors or other intermediaries are used to distribute paper documentation to customers. This methodology would be particularly useful when, for example, a financial institution such as a mortgage company is distributing escrow checks, bill statements, notification letters, etc. that may be subject to regulatory and/or audit requirements. The disclosed methodology can be implemented using ad hoc and/or batched processing via a SQL database and .net coding plus schedules of jobs running on a server.

In accordance with the methodology, an entity 201 utilizes an embedding software application 203 to embed metadata that includes a search key data string within digital text of a digital document (e.g., a portable document format (PDF)). The metadata at this stage in the process may include, for example, document type, customer information, and/or account information of the customer. The metadata is hidden and visually undetectable to the unaided eye due to the metadata being disguised using a font color that blends in with the background of the document. For instance, the font color of the text of the metadata may be white against a white backgrounds such that the digital text of the digital document is visually-undetectable. In some instances several digital documents can be compressed (i.e. zipped) into a file or folder 205 for batch processing.

The folder 205 of compressed digital documents may be transmitted across a network to a print vendor 207, and the print vendor can extract the metadata based on having been previously advised as to where on the digital document the metadata is located. The print vendor 207 may then update the metadata of the digital document to indicate that the digital document was transmitted to the print vendor 207. The print vendor 207 may archive the digital document to a database 211, and update the metadata to indicate the archival process has occurred. Further, the print vendor 207 may physically print one or more copies of the digital document, and update the metadata of the archived digital document to indicate that one or more copies have been printed. Further, the print vendor may mail, via a mail courier, a physically printed copy of the digital document to the customer 209, and update the metadata of the archived digital document with various information related to mailing such as, for example, when the printed copy of the digital document has been mailed, where the printed copy of the digital document was mailed from, where the printed copy of the digital document was mailed to, tracking number information used by the mail courier, the type of mailing classification used (e.g., first class, priority, priority mail express, ground, standard, overnight, same-day, two-day, etc.), and/or certification information (e.g. mailing receipt, verification that the mailpiece was delivered, etc.).

Periodically (e.g., every hour, every day, every night, every other day, etc.) and/or in real time, a report record 213 that is reported back to a database 215 such as a relational database (e.g., SQL database). Various .net programs/frameworks that can run on the operating system of the entity may be coded and used to indicate a status of a document's lifecycle in digital and/or physical print format. In particular, the digital document of the database 215 may be dated in order to indicate the exact data certain events in the document lifecycle occurred. In some embodiments, a console application or command-line program may be used to aggregate all of the data to provide a centralized reporting for individuals within the entity 201 of each document.

Further coding provides visibility to show whether physical documentation is being provided in accordance with service-level agreement (SLA) requirements and/or audit requirements. In some embodiments, alerts may programmed to alert a user if the SLA requirements are not met due to, for example, a delay in getting the document mailed, and the aggregated data derived from the metadata of the document stored to the database 215 may be referenced to indicate where the document is or was in the document lifecycle.

In some embodiments, when the metadata is embedded via the embedding software application 203, the document is indexed to the database 215 with various information to facilitate tracking the document including, for example, a letter identification number, a customer number, an account number, etc. The index table referencing the digital document is updated with dates as the report record 213 is received.

FIG. 3 depicts an example process for providing a visually-undetectable font color tracking system for physically printing documents. In particular, a document 300A may include metadata 302A that is used to track the status of the document 300A. The metadata 302A may be rendered in a format, as shown with document 300B, where the metadata 302B includes a visually-undetectable font color that blends in with a background. In some instances, the font color may be a white font color that is the same color of the background of the document. In other instances, a colored bar or other aspect of the letter may be used to indicate where the metadata can be found, but the metadata itself is in a font color that blends in with the color of the colored bar.

FIG. 4 depicts a block diagram of an example method 400 of a visually-undetectable font color tracking system for physically printing and distributing print documentation, in accordance with an embodiment of the present invention. At block 405, one or more digital documents are transmitted across a network to a third-party entity, where the one or more digital documents include metadata that includes a search key data string located within digital text of the one or more digital documents. The metadata includes a visually-undetectable font color and the one or more digital documents are transmitted to the third-party entity for physical printing and distribution, where the physical printing is based on converting the digital text into physical text printed on paper.

At block 410, one or more communications are received across the network from a third-party entity that includes archived status update information regarding physical printing and distribution of one or more physical documents associated with the one or more digital documents. In addition, the one or more communications include the metadata that includes an updated version of the search key data string.

At block 415, based on receiving the one or more communications and using the updated version of the search key data string, a status assessment is generated that identifies status of the physical printing and the distribution of the one or more physical documents performed by the third-party entity.

According to various embodiments, the generated status assessment is compared to one or more service-level agreement constraints for the distribution of the one or more physical documents. Further, a notification may be distributed indicating at least one of the one or more physical documents was not distributed in accordance with the one or more service-level agreement constraints. For instance, the generated status assessment may be configured to comply with regulatory and audit requirements of an entity.

In some implementations, every document that is distributed to the client may pass through the entity's document distribution system such that the one or more digital documents include every customer communication document. In some embodiments, the one or more digital documents include one or more financial documents associated with an entity's financial services. In some embodiments, the third-party entity may include a print vendor that utilizes a data extraction tool capable of extracting the metadata. In some embodiments, the metadata that includes the visually-undetectable font color is located at a location on the one or more digital documents that has been previously communicated to the third-party entity so that the third-party entity can extract the metadata. In some embodiments, the one or more digital documents are transmitted to the third-party entity in compressed format (e.g., zipped).

In addition, in some examples, the methodology may index information associated with the one or more digital documents to a database of the entity for tracking purposes so that the index table of the database may be updated as information is received from the third-party entity. In particular, the index information may be updated with one or more dates associated with physical printing and distribution of the one or more physical documents, and the generated status assessment incorporates the one or more dates.

According to various embodiments, the metadata includes at least one selected from the group that includes document type, physical documentation origination location, mailing information, shipment tracking information, mailing classification, certification information, customer information, and account information.

FIG. 5 depicts a block diagram of an example method 500 for print document reconciliation, in accordance with an embodiment of the present invention. At block 505, one or more digital documents is received from an entity an via an embedding software application, where the one or more digital documents include metadata that includes a search key data string located within digital text of the one or more digital documents, where the metadata includes a visually-undetectable font color. At block 510, the one or more digital documents received are archived, and at block 515 one or more copies of the one or more digital documents are physically printed for distribution. At block 520, one or more communications are distributed regarding the physically printed one or more copies and distribution of the physically printed one or more copies, where the one or more communications include the metadata that includes an updated version of the search key data string.

In some embodiments, an updated version of the search key data string is updated with information indicating that the one or more digital documents have been physically printed for distribution. Further, the updated version of the search key data string may be further updated with shipping information associated with mailing a copy of the physically printed one or more copies. In some embodiments, the shipping information of the updated version of the search key data string includes at least one selected from the group consisting of a mailing method used by a mailing entity that was used to mail the copy, physical documentation origination location, shipment tracking information, mailing classification, mailing information, and certification information. In some embodiments, the search key data string located within the digital text of the one or more digital documents includes at least one selected from the group consisting of a document type, customer information and account information.

According to various embodiments, the method further includes receiving, based on all of the data provided via the one or more user inputs satisfying the plurality of threshold requirements, a request to certify the data. In response, the data may then be certified. In some embodiments, the method further includes generating and displaying, based on at least a portion of the data provided via the one or more user inputs being deficient in at least one of the plurality of threshold requirements, an error message indicating an issue that needs to be corrected before the data can be certified.

In some embodiments, the one or more user inputs further include an indication of a physical location at which the demand could be satisfied. Further, the physical location may include at least one of a territorial region and a physical worksite facility. In some embodiments, the one or more user inputs may further include an attribute type associated with the urgency of the demand.

In some embodiments, the one or more user inputs further include a resource assessment of at least one unit resources of the enterprise, where the resource assessment includes an indication of areas of expertise associated with the at least one unit resource. In some embodiments, the resource assessment further indicates one or more resource attributes attributed to the at least one unit resource, and a skill level associated with the one or more resource attributes. The method may also include assigning a score to the one or more resources of the enterprise, where the score is based on one or more resource attributes attributed to the at least one unit resource. Further, the resource assessment may be performed by a manager of the at least one unit resource.

The method may also include generating a summary configured to provide insights of various data derived from the one or more user inputs. In some embodiments, the method further includes transmitting to and displaying via the one or more computing devices, the summary, where the summary is configured to be filtered based on one or more parameters selected, via one or more input controls, by a user of at least one of the one or more computing devices. In some example embodiments, the summary may be further configured to provide insights of enterprise data derived from third-party systems.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®”, “Windows®”, “macOS®”, “iOS®”, “Android®”, and the like may be subject to trademark rights in various jurisdictions throughout the world and are used here only in reference to the products or services properly denominated by the marks to the extent that such trademark rights may exist.

What is claimed is:

1. A visually-undetectable font color tracking system for physically printing and distributing print documentation, the system comprising:
a memory;
one or more processors in communication with the memory; and
program instructions executable by the one or more processors via the memory to:
transmit, across a network, one or more digital documents to a third-party entity, wherein the one or more digital documents comprises metadata comprising a search key data string located within digital text of the one or more digital documents, the metadata comprising a visually-undetectable font color, the one or more digital documents being transmitted to the third-party entity for physical printing, based on converting the digital text into physical text printed on paper, and distribution;
receive, across the network, one or more communications from the third-party entity comprising archived status update information regarding physical printing and distribution of one or more physical documents associated with the one or more digital documents, the one or more communications comprising the metadata comprising an updated version of the search key data string; and
generate, based on receiving the one or more communications and using the updated version of the search key data string, a status assessment identifying status of the physical printing and the distribution of the one or more physical documents performed by the third-party entity.

2. The system according to claim 1, wherein the program instructions are further executable to:
compare the generated status assessment to one or more service-level agreement constraints for the distribution of the one or more physical documents; and
distribute a notification indicating a least one of the one or more physical documents was not distributed in accordance with the one or more service-level agreement constraints.

3. The system according to claim 1, wherein the one or more digital documents comprising every customer communication document that processes through an entity's document distribution system.

4. The system according to claim 1, wherein the one or more digital documents comprise one or more financial documents associated with an entity's financial services.

5. The system according to claim 1, wherein the status assessment is configured to comply with regulatory and audit requirements of an entity.

6. The system according to claim 1, wherein the third-party entity comprises a print vendor comprising a data extraction tool capable of extracting the metadata.

7. The system according to claim 1, wherein the one or more digital documents are transmitted to the third-party entity in compressed format.

8. The system according to claim 1, wherein the metadata comprises at least one selected from the group consisting of document type, physical documentation origination location, mailing information, shipment tracking information, mailing classification, certification information, customer information, and account information.

9. The system according to claim 1, wherein the program instructions are further executable to index information associated with the one or more digital documents.

10. The system according to claim 9, wherein the index information is updated with one or more dates associated with the physical printing and the distribution of the one or more physical documents, and wherein the generated status assessment incorporates the one or more dates.

11. The system according to claim 1, wherein the metadata comprising the visually-undetectable font color is located at a location on the one or more digital documents that is previously communicated to the third-party entity.

12. A computing environment for print document reconciliation, the computing environment comprising:
one or more computer-readable storage media;
one or more processors in communication with the one or more computer-readable storage media; and
program instructions executable by the one or more processors via at least one computer-readable storage medium of the one or more computer readable storage media to:
receive, from an entity and via an embedding software application, one or more digital documents comprising metadata that comprises a search key data string located within digital text of the one or more digital documents, the metadata comprising a visually-undetectable font color;
archive, the one or more digital documents received;
physically print one or more copies of the one or more digital documents for distribution; and
distribute one or more communications regarding the physically printed one or more copies and distribution of the physically printed one or more copies, the one or more communications comprising the metadata that comprises an updated version of the search key data string.

13. The computing environment of claim 12, wherein the program instructions are further executable to generate the updated version of the search key data string with information indicating that the one or more digital documents have been physically printed for distribution.

14. The computing environment of claim 13, wherein the updated version of the search key data string is further updated with shipping information associated with mailing a copy of the physically printed one or more copies.

15. The computing environment of claim 14, wherein the shipping information of the updated version of the search key data string includes at least one selected from the group consisting of a mailing method used by a mailing entity used to mail the copy, physical documentation origination location, shipment tracking information, mailing classification, mailing information, and certification information.

16. The computing environment of claim 12, wherein the search key data string located within the digital text of the one or more digital documents includes at least one selected from the group consisting of a document type, customer information, and account information.

17. A computer-implemented method, comprising:
transmitting, across a network, one or more digital documents to a third-party entity, wherein the one or more digital documents comprises metadata comprising a search key data string located within digital text of the one or more digital documents, the metadata comprising a visually-undetectable font color, the one or more digital documents being transmitted to the third-party entity for physical printing, based on converting the digital text into physical text printed on paper, and distribution;
receiving, across the network, one or more communications from the third-party entity comprising archived status update information regarding physical printing and distribution of one or more physical documents associated with the one or more digital documents, the one or more communications comprising the metadata comprising an updated version of the search key data string; and
generating, based on receiving the one or more communications and using the updated version of the search key data string, a status assessment identifying status of the physical printing and the distribution of the one or more physical documents performed by the third-party entity.

18. The computer-implemented method of claim 17, wherein the method further comprises:
comparing the generated status assessment to one or more service-level agreement constraints for the distribution of the one or more physical documents; and
distributing a notification indicating a least one of the one or more physical documents was not distributed in accordance with the one or more service-level agreement constraints.

19. The computer-implemented method of claim 17, wherein the updated version of the search key data string comprises at least one selected from the group consisting of a mailing method used by a mailing entity used to mail a copy of the one or more physical documents, physical documentation origination location, shipment tracking information, mailing classification, mailing information, and certification information.

20. The computer-implemented method of claim 17, wherein the search key data string located within the digital text of the one or more digital documents includes at least one selected from the group consisting of a document type, customer information, and account information.
